(19) United States
(12) Patent Application Publication
(10) Pub. No.: US 2013/0332206 A1
(43) Pub. Date: Dec. 12, 2013

(54) Out-of-Pocket Insurance

(71) Applicant: Kalyan Chakravarthy Dommalapati, Bellevue, WA (US)

(72) Inventor: Kalyan Chakravarthy Dommalapati, Bellevue, WA (US)

(21) Appl. No.: 13/847,994

(22) Filed: Mar. 20, 2013

Related U.S. Application Data
(60) Provisional application No. 61/657,569, filed on Jun. 8, 2012.

(51) Int. Cl. G06Q 40/08

(52) U.S. Cl. CPC G06Q 40/08
USPC 705/4

(57) ABSTRACT

Technologies related to out-of-pocket insurance are described. In some examples, out-of-pocket insurance covers the out-of-pocket costs associated with making an insurance claim with a primary insurance provider. This out-of-pocket insurance coverage may cover any payment that an insurance policy holder must pay out-of-pocket in a valid insurance plan for valid insurance claims.

### FIELD

This disclosure relates to an out-of-pocket insurance.

### BACKGROUND

Insurance is a tool utilized by many individuals to protect against unforeseen large costs. In the United States, nearly all people hold some form of insurance to provide coverage for their automobiles, homes, health, or property. Insurance policies can be quite complex and typically seek to charge an individual, company, or other entity a premium based on the risk of an adverse event happening to the individual, company, or other entity. In many cases, the insurance policy holder must pay some sort of out-of-pocket costs, such as a deductible or co-pay, before the insurance provider will pay for the rest of the cost. These deductibles can pose a significant financial burden on individuals, especially in cases where the individual has a low-premium, high-deductible insurance policy.

Some auto insurance providers have what is known as “gap insurance,” which covers the difference between the value of a vehicle at the time of a claim and the amount paid for it. Other providers offer a plan to cover your deductible in the event of a claim to a primary insurance policy, which requires that the claim exceed the deductible of the primary insurance policy.

### SUMMARY

The present disclosure generally describes, among other things, technologies applicable to out-of-pocket insurance. In one embodiment, out-of-pocket insurance may be provided, allowing a customer to receive funds after an insured loss to cover up to a deductible amount of a primary insurance policy. The technologies may include an ability to receive an insurance claim, confirm the validity of a primary insurance policy covering the insurance claim, confirming the validity of the insurance coverage, and providing payment for the out-of-pocket costs of the insurance claim.

Examples of primary insurance may include automotive, home, health, earthquake, terrorism, professional liability, business interruption, pet, travel, and real property insurance types. Example third party out-of-pocket insurance coverage may comprise co-pays, deductibles, or other out-of-pocket expenses.

An insurance claim may be received by electronic means, such as from a website, e-mail, text message, or instant message, or may be received by phone or an office visit.

Other features, objects, and advantages of this disclosure will become apparent from the following description, taken in connection with the accompanying drawing, wherein, by way of illustration, example embodiments of the invention are disclosed.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram illustrating an example out-of-pocket insurance system.

FIG. 2 is a flow diagram illustrating example methods for customer and insurance provider interactions.

FIG. 3 illustrates a component diagram of a computing device according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, inter alia, to out-of-pocket insurance. In some examples, individuals and entities may seek insurance coverage for the out-of-pocket costs associated with making an insurance claim with a primary insurance provider. This out-of-pocket insurance coverage may cover any payment that a valid insurance policy holder must pay out-of-pocket for valid insurance claims.

In some embodiments, the primary insurance may cover automotive, home, health, earthquake, terrorism, professional liability, business interruption, pet, travel, and property.

In some embodiments, the out-of-pocket insurance system may be configured to cover co-pays, deductibles, or other out-of-pocket expenses. The out-of-pocket expenses may arise from any type of primary insurance coverage type and the out-of-pocket expense value may be any number greater than zero. The out-of-pocket expense may have a value lower than the deductible in the primary insurance policy. The out-of-pocket insurance system may be configured to cover out-of-pocket expenses regardless of the value of the insurance coverage.

In one embodiment, a claim from an out-of-pocket insurance policy holder may be received by an out-of-pocket insurer. The claim may include information about a primary insurance policy and a claim made to a provider of that policy. Validity of the primary insurance policy may be confirmed based on data provided by a client or from data provided by a primary insurance provider, and validity of the insurance claim may be confirmed based on data provided by a policy holder or a primary insurance provider. One having skill in the art will recognize that validity of claims and policies may be obtained from various sources and using various techniques.

If the claim made to the primary insurance provider is validated and verified, a payment may be made to the out-of-pocket insurance policy holder for corresponding out-of-pocket expenses.

In another embodiment, damages may not reach a level to require a primary insurance claim. For example, a theft of an object worth $800.00 would not justify a claim against a primary policy with a $1000.00 deductible. An out-of-pocket insurance policy may still cover such a situation if the loss would be a valid claim if it exceeded the $1000.00 deductible; i.e. the primary insurance would cover that type of loss.

The out-of-pocket insurance claim may be received by a webpage, dedicated application, an e-mail, a text message, or an instant message. The insurance claim may also be received by phone or office visit.

Out-of-pocket insurance policies may be negotiated for in the same way primary insurance policies may be negotiated for through GEICO®, STATE FARM®, ALLSTATE®, etc. The insurance provider for out-of-pocket insurance may be a third party insurer or the same insurance provider that provides the primary insurance policy.

In one embodiment, the insurance policy holder may pay for an out-of-pocket insurance policy in monthly, semi-monthly, or annual payments, using a bank checking/savings/debit or credit card. In another embodiment, the insurance policy holder may pay for the out-of-pocket insurance policy at any time increment and using any desired payment method.

In one embodiment, the out-of-pocket insurance policy may kick-in when a valid insurance claim is made with the primary insurance provider. In another embodiment, the primary insurance provider may confirm the validity of the primary insurance policy and validity of the insurance claim with the out-of-pocket insurance provider. The out-of-pocket insurance provider may then be configured to pay the out-of-pocket expense to the policy holder, directly to the primary insurance provider, or to a party that is the final recipient of the insurance payout.

A third party out-of-pocket insurance provider may streamline communication by opening up an information technology (IT) dataflow between insurance companies that are involved in the claim process, which may enable direct confirmation of validity of a primary insurance policy and validity of an insurance claim, in addition to transfer of money between the two insurance entities involved or an end recipient of the insurance reimbursement.

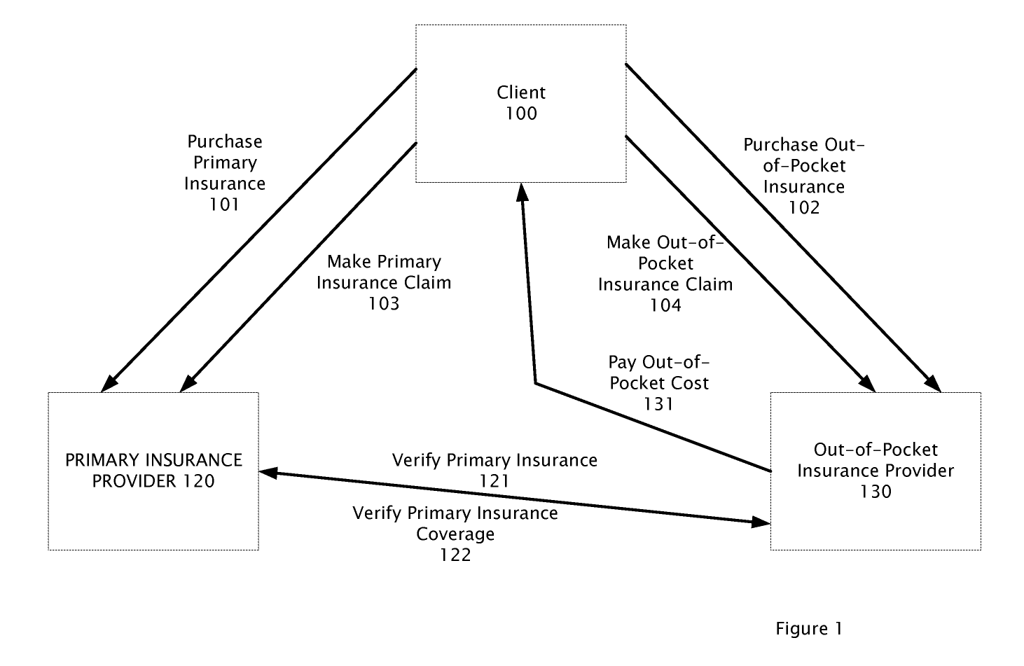

FIG. 1 is a block diagram illustrating an example out-of-pocket insurance system, arranged in accordance with at least some embodiments of the present disclosure. FIG. 1 includes a client 100, a primary insurance provider 120, and an out-of-pocket insurance provider 130.

In one embodiment, a client may purchase a number of insurance products to cover various needs and risks. In FIG. 1, Client 100 may Purchase Primary Insurance 101 to cover an automobile. Primary insurance may cover, for example, home, professional liability, health, pets, or travel. Additionally, Client 100 may further reduce potential financial hardship by purchasing Out-of-Pocket Insurance 102 to cover potential out-of-pocket expenses comprising co-pays and deductibles in an insurance claim to Primary Insurance Provider 120.

For example, Client 100's automobile may have been hit by a second automobile through the fault of a driver of the second automobile. Client 100 may Make Primary Insurance claim 103 to cover the costs of repairing Client 100's automobile and other related expenses. Client 100 may also make Out-of-Pocket Insurance claim 104 with Out-of-Pocket Insurance Provider 130 to cover the out-of-pocket costs from Insurance claim 103 with the Primary Insurance Provider 120.

Out-of-Pocket Insurance Provider 130 may confirm validity of a primary insurance policy by Verify Primary Insurance 121. Validity of the primary insurance policy may be confirmed by data provided by Primary Insurance Provider 120 or Client 100.

Out-of-Pocket Insurance Provider 130 may confirm validity of an insurance claim by Verify Insurance claim 122. Validity of the insurance claim may be confirmed by data provided by Primary Insurance Provider 120 and Client 100.

Out-of-Pocket Insurance Provider 130 may Pay Out-of-Pocket Cost 131 if validity of the primary insurance policy and validity of the insurance claim have been confirmed. Pay Out-of-Pocket Cost 131 may be paid directly to Primary Insurance Provider 120, Client 100, or to a third-party end recipient of the insurance reimbursement.

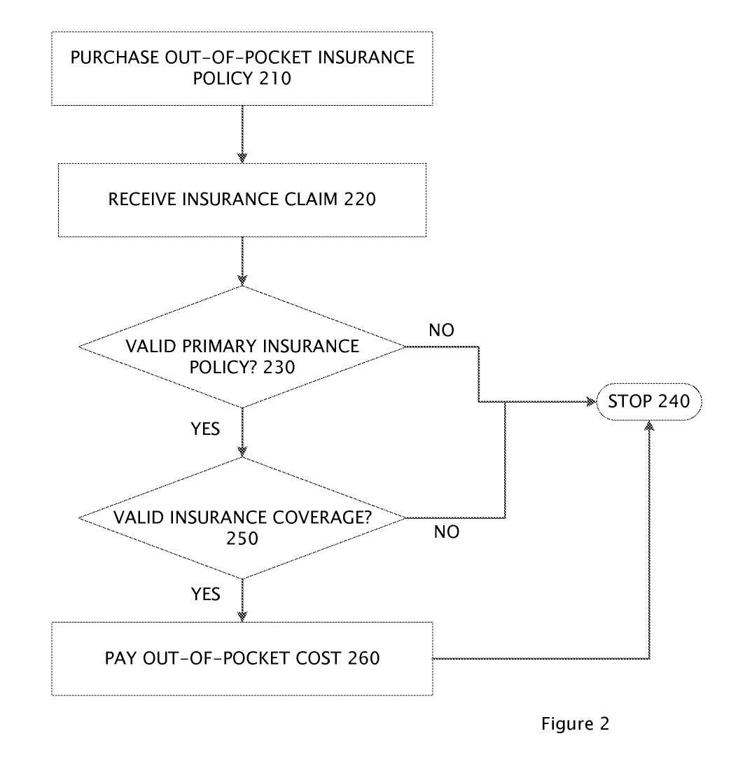

FIG. 2 is a flow diagram illustrating one example method for customer and insurance provider interactions, arranged in accordance with at least some embodiments of the present disclosure. The example flow diagram may include one or more operations/modules as illustrated by blocks 210-260, which represent operations as may be performed in a method, functional modules in a computing device 1300, and/or instructions as may be recorded on a computer readable medium Storage 1306. The illustrated blocks 210-260 may be arranged to provide functional operations of “Purchase Out-Of-Pocket Insurance Policy” at block 210, “Submit Insurance Claim” at block 220, “Valid Primary Insurance Policy?” at decision block 230, “Stop” at block 240, “Valid Insurance Claim?” at decision block 250, and “Pay Out-Of-Pocket Cost” at block 260.

In FIG. 2, blocks 210-260 are illustrated as including blocks being performed sequentially, e.g., with block 210 first and block 260 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

In “Sell Out-Of-Pocket Insurance Policy” block 210, an insurance policy issuer may sell a holder of a primary insurance policy out-of-pocket insurance, which may reduce the potential financial burden of the holder for paying out-of-pocket expenses in the event an insurance claim is made on the primary insurance policy.

In a “Receive Insurance Claim” block 220, the policy holder may have encountered a circumstance that gives rise to making an insurance claim. In this example, the out-of-pocket insurance provider may receive an insurance claim from a policy holder.

In a “Valid Primary Insurance Policy?” decision block 230, the out-of-pocket insurance provider may take action to confirm the validity of the primary insurance policy. Validity may be confirmed by data provided by the policy holder and the primary insurance provider. If validity of the primary insurance policy is not confirmed, then block 240 may follow. If validity of the primary insurance policy is confirmed, then decision block 250 follows.

In a “Stop” block 240, the primary insurance policy may not have been valid and the out-of-pocket insurance provider may be configured to stop further action on the claim. Alternatively, the insurance claim may not have been deemed valid, and the out-of-pocket insurance provider may be configured to stop further action on the claim. In addition, if payment of the out-of-pocket cost has been made, then the insurance claim may be completed and no further action may be required.

In a “Valid Insurance Coverage?” decision block 250, the out-of-pocket insurance provider may take action to confirm the validity of the insurance coverage. Validity may be indicated by a valid claim to the primary insurance provider, or may be indicated by verifying that the loss would be covered by the primary insurance provider, even if a claim is not made. Validity may be confirmed by data provided by the policy holder and the primary insurance provider. If validity of the insurance claim is not confirmed, then block 240 may follow. If validity of the insurance claim is confirmed, then decision block 260 may follow.

In a “Pay Out-Of-Pocket Cost” block 260, the out-of-pocket insurance provider may have confirmed the validity of both primary insurance and an insurance claim, and may accordingly pay the out-of-pocket cost that was covered under the out-of-pocket insurance policy. The payment may be made directly to the policy holder, the primary insurance provider, or the end recipient of the payment, whichever may be efficient or agreed upon under the policy contract.

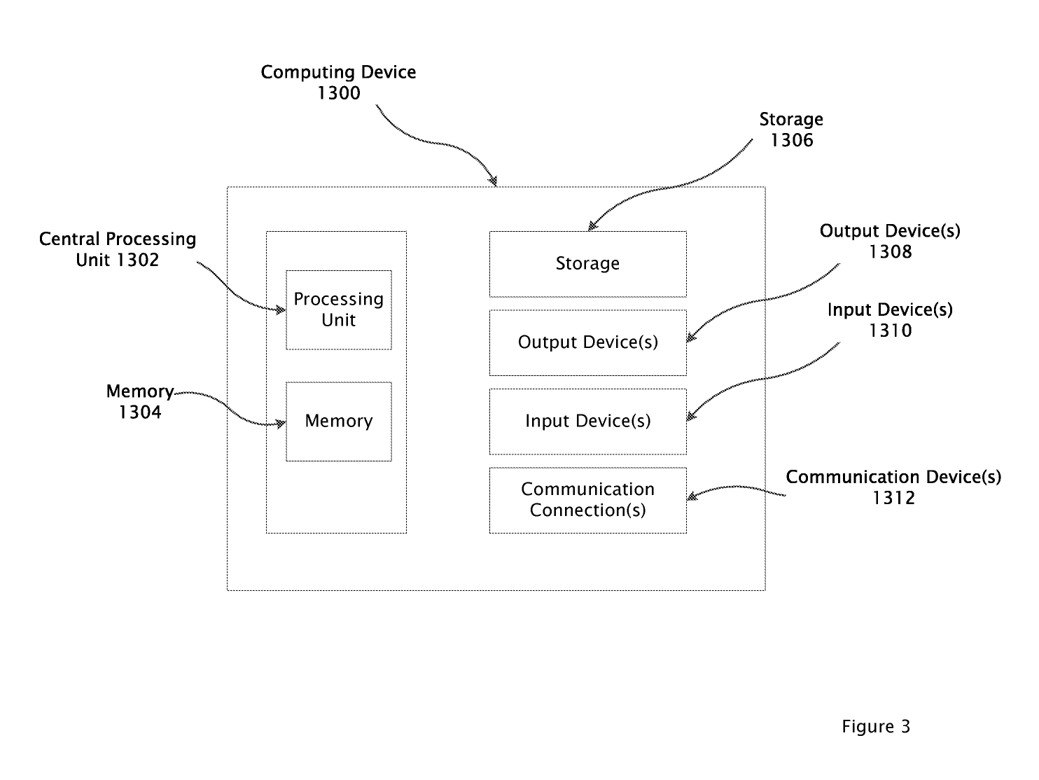

FIG. 3 illustrates a component diagram of a computing device according to one embodiment. The Computing Device (1300) can be utilized to implement one or more computing devices, computer processes, or software modules described herein. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer readable storage media includes volatile and nonvolatile, removable and non-removable media implemented in any method or technology for storage of information such as computer readable instructions, data structures, program modules or other data. Memory (1304) and Storage (1306) are all examples of computer storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transient medium which can be used to store the desired information and which can accessed by computing device (1300). Any such computer readable storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed.

Moreover, steps may be added to the above described logic and still conform to the described embodiments. Further, operations described herein may occur sequentially or certain operations may be processed in parallel. Yet further, operations may be performed by a single processing unit or by distributed processing units.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Because many embodiments of the invention can be made without departing from the spirit and scope of the invention, the invention resides in the claims hereinafter appended.

1. A method for an out-of-pocket insurance coverage by an out-of-pocket insurance system comprising:
receiving an insurance claim by the out-of-pocket insurance system;
confirming validity of a primary insurance policy by the out-of-pocket insurance system;
confirming validity of an insurance claim by the out-of-pocket insurance system; and
providing payment for the insurance claim by the out-of-pocket insurance system.

2. The method of claim 1, wherein the primary insurance policy is of a type selected from a group consisting of automotive, home, health, earthquake, terrorism, professional liability, business interruption, pet, travel, and property.

3. The method of claim 1, wherein the out-of-pocket coverage comprises co-pays, deductible, or other out-of-pocket expenses.

4. The method of claim 1, wherein confirming validity of the primary insurance policy is based on data provided by a group consisting of a client and a primary insurance provider.

5. The method of claim 1, wherein confirming validity of the insurance claim is based on data provided by a group consisting of a client and a primary insurance provider.

6. A system, comprising:
a processor;
a memory coupled to the processor;
components operable by the processor, comprising:
an insurance claim receiving component, configured to receive an insurance claim originating from a client;
a policy confirming component, configured to confirm validity of the primary insurance policy;
a claim confirming component, configured to confirm validity of the insurance claim; and
a payment providing component, configured to provide payment for the insurance claim.

7. The system of claim 6, wherein the insurance claim receiving component receives the insurance claim from a group consisting of a webpage dedicated application, an e-mail, a text message, and an instant message.

8. The system of claim 6, wherein the insurance claim receiving component receives the insurance claim via a group consisting of a phone and an office visit.

9. A computer readable storage medium having stored thereon instructions which, when executed by a processor, execute a method, comprising:
receiving an insurance claim by an out-of-pocket insurance system;
confirming validity of a primary insurance policy by the out-of-pocket insurance system;
confirming validity of an insurance claim by the out-of-pocket insurance system;
providing payment for the insurance claim by the out-of-pocket insurance system;

10. The computer readable storage medium of claim 9, wherein the primary insurance policy is of a type selected from a group consisting of automotive, home, earthquake, terrorism, professional liability, business interruption, pet, travel, and property.

11. The computer readable storage medium of claim 9, wherein the out-of-pocket coverage comprises co-pays, deductible, or other out-of-pocket expenses.

12. The computer readable storage medium of claim 9, wherein confirming validity of the primary insurance policy is based on data provided by a group consisting of a client and a primary insurance provider.

13. The computer readable storage medium of claim 9, wherein confirming validity of the insurance claim is based on data provided by a group consisting of a client and a primary insurance provider.
